(19) United States
(12) Patent Application Publication
(10) Pub. No.: US 2018/0086444 A1
(43) Pub. Date: Mar. 29, 2018

(54) Aircraft Drive System

(71) Applicant: Bell Helicopter Textron Inc., Forth Worth, TX (US)

(72) Inventors: Scott David Poster, Arlington, TX (US); Walter Riley, Fort Worth, TX (US); Gary Cope, Keller, TX (US); Charles Hubert Speller, JR., Flower Mound, TX (US)

(21) Appl. No.: 15/702,912

(22) Filed: Sep. 13, 2017

Related U.S. Application Data
(60) Provisional application No. 62/399,097, filed on Sep. 23, 2016.
(60) Provisional application No. 62/423,371, filed on Nov. 17, 2016.

(51) Int. Cl. B64C 27/14; B64D 35/00; F16H 57/02; F16H 57/04; F16H 1/28; F16D 3/00

(52) U.S. Cl. CPC B64C 27/14; B64D 35/00; F16H 57/02; F16H 57/0413; F16C 2326/43; F16D 3/00; F16H 2057/02026; F16H 2057/02043; F16H 1/28

(57) ABSTRACT

The present invention includes an aircraft drive system comprising a main rotor gearbox comprising a first and a second input; a first drive system comprising a first engine reduction gearbox connecting a first engine to the first input of the main rotor gearbox at a reduced shaft speed; and a second drive system independent from and redundant with the first drive system, the second drive system comprising a second engine reduction gearbox connecting a second engine to the second input of the main rotor gearbox at the reduced shaft speed.

### CROSS-REFERENCE TO RELATED APPLICATIONS

This patent application claims priority to U.S. provisional patent application Ser. No. 62/399,097 filed on Sep. 23, 2016 entitled “Improved Helicopter Transmission System” and U.S. provisional patent application Ser. No. 62/423,371 filed on Nov. 17, 2016 entitled “Improved Helicopter Transmission System,” all of which are hereby incorporated by reference in their entirety.

### STATEMENT OF FEDERALLY FUNDED RESEARCH

Not applicable.

### TECHNICAL FIELD OF THE INVENTION

The present invention relates in general to the field of drive systems, and more particularly, to a novel drive system configuration for use in an aircraft, for example, a rotorcraft.

### BACKGROUND OF THE INVENTION

Without limiting the scope of the invention, its background is described in connection with rotorcraft drive systems.

Since their inception, rotorcraft and rotorcraft drive systems have been improved to reduce the possibility of failure during flight. Toward that end, a number of modifications have been made to drive systems to improve reliability. However, despite advances in materials and design, a number of failures continue to occur that affect rotorcraft performance. One example of a problem with current rotorcraft drive systems is that, in some instances, the failure of single drive system component leads to failure of the entire drive system. Another example is a loss of lubrication event that causes the loss of torque transmission by drive system subcomponents such as gearboxes or accessories connected to the main rotor gearbox.

More particularly, the failure of a single gearbox or shaft connected to the main rotor gearbox can significantly impact operations. For example, if there is a loss of lubrication to a gearbox, the gearbox loses torque transmission, causing damage to upstream or downstream components. The same can occur when a shaft becomes unbalanced (or breaks), which can damage couplings, gearboxes and even the main rotor gearbox. Unfortunately, when a portion of a drive system experiences a failure or reduction in performance, the concomitant reduction in power leads to challenges with flight performance.

Thus, a need remains for improving the overall safety and reliability of rotorcraft drive systems that include the connections between the engines and the main rotor gearbox, reduction and accessory gearboxes, shafts, generators, oil pumps, and accessories connected to the main rotor gearbox. Specifically, systems and methods that minimize the number of single load path components, provide maximum system separation and redundancy, minimize maintenance required and maintenance related incidents, minimize the potential of loss of lubrication events, and maximize main rotor gearbox loss of lubrication capability are desirable, including systems and methods for cooling components and systems during normal operations and during loss of lubrication events.

### SUMMARY OF THE INVENTION

In one embodiment, the present invention includes an aircraft dual drive system comprising: a main rotor gearbox comprising a first and a second input; a first drive system comprising a first engine reduction gearbox connecting a first engine to the first input of the main rotor gearbox at a reduced shaft speed; and a second drive system independent from and redundant with the first drive system, the second drive system comprising a second engine reduction gearbox connecting a second engine to the second input of the main rotor gearbox at the reduced shaft speed. In one aspect, the first and second engine reduction gearboxes comprises a plurality of gears that reduce a shaft speed from the first and second engines from a high speed at or near turbine engine speed of greater than 10,000 revolutions per minute at an input of the first and second engine reduction gearboxes, respectively, to a speed substantially lower than the high speed, a low speed of less than about 6,000 revolutions per minute at an output of the first and second engine reduction gearboxes. In another aspect, the drive system further comprises a drive shaft with flexible couplings connecting each of the first and second engine reduction gearboxes to the first and second inputs of the main rotor gearbox, respectively. In another aspect, each of the first and second engine reduction gearboxes is independently lubricated and cooled. In another aspect, each of the first and second engine reduction gearboxes are configured to be independently decoupled from the main rotor gearbox. In another aspect, an output shaft comprises a tail rotor disc brake and calipers for slowing or stopping the drive system. In another aspect, the main rotor gearbox comprises a low speed overhung planetary gear system. In another aspect, drive system further comprises a drive shaft assembly connected to an output of the main rotor gearbox, wherein the drive shaft assembly comprises one or more drive shafts, each of the drive shafts connected to one or more bearing assemblies, the drive shaft assembly having a proximal and a distal end, and an intermediate gear box connected to the distal end of the one or more drive shafts, wherein the intermediate gear box is connected to a tail rotor gearbox via a tail rotor drive shaft. In another aspect, drive system further comprises at least one of: one or more accessory gearboxes, one or more cooling fans, or one or more oil pumps, one or more hydraulic power packs, or one or more generators, each connected directly or indirectly to the main rotor gearbox independently. In another aspect, drive system further comprises an oil cooler mounted directly to the main rotor gearbox. In another aspect, drive system further comprises a first accessory gearbox connecting the main rotor gearbox with one or more accessories, the first accessory gearbox having a non-pressurized lubrication system independent from a lubrication system associated with the main rotor gearbox; and a second accessory gearbox connecting the main rotor gearbox with one or more accessories, the second accessory gearbox having a non-pressurized lubrication system independent from a lubrication system associated with the main rotor gearbox, wherein the second accessory gearbox is independent from and redundant with the first accessory gearbox. In another aspect, drive system further comprises two or more hydraulic power packs wherein each of the two or more hydraulic power packs is independent from and redundant with the other hydraulic power packs. In another aspect, drive system further comprises two or more oil cooler blowers wherein each of the two or more oil cooler blowers is independent from and redundant with the other oil cooler blowers. In another aspect, drive system further comprises two or more generators wherein each of the two or more generators is independent from and redundant with the other generators.

In another embodiment, the present invention includes a method of providing redundant power to a main rotor gearbox comprising: providing the main rotor gearbox comprising a first and a second input; connecting a first drive system comprising a first engine reduction gearbox connecting a first engine to the first input of the main rotor gearbox at a reduced shaft speed; and connecting a second drive system independent from and redundant with the first drive system, the second drive system comprising a second engine reduction gearbox connecting a second engine to the second input of the main rotor gearbox at the reduced shaft speed. In one aspect, the first and second engine reduction gearboxes comprises a plurality of gears that reduce a shaft speed from the first and second engines from up to a high speed at or near turbine engine speed of greater than 10,000 revolutions per minute at an input of the first and second engine reduction gearboxes, respectively, to a speed substantially lower than the high speed, a low speed of less than about 6,000 revolutions per minute at an output of the first and second engine reduction gearboxes. In another aspect, the method further comprises connecting a drive shaft with flexible couplings between each of the first and second engine reduction gearboxes and the first and second inputs of the main rotor gearbox, respectively. In another aspect, each of the first and second engine reduction gearboxes is independently lubricated and cooled. In another aspect, each of the first and second engine reduction gearboxes are configured to be independently decoupled from the main rotor gearbox. In another aspect, an output shaft comprises a tail rotor disc brake and calipers for slowing or stopping the drive system. In another aspect, the main rotor gearbox comprises a low speed overhung planetary gear system. In another aspect, the method further comprises connecting a drive shaft assembly to an output of the main rotor gearbox, wherein the drive shaft assembly comprises one or more drive shafts, each of the drive shafts connected to one or more bearing assemblies, the drive shaft assembly having a proximal and a distal end, and an intermediate gear box connected to the distal end of the one or more drive shafts, wherein the intermediate gear box is connected to a tail rotor gearbox via a tail rotor drive shaft. In another aspect, the method further comprises providing at least one of: one or more accessory gearboxes, one or more cooling fans, or one or more oil pumps, one or more hydraulic power packs, or one or more generators, each connected directly or indirectly to the main rotor gearbox independently. In another aspect, the method further comprises mounting an oil cooler directly to the main rotor gearbox. In another aspect, the method further comprises mounting a first accessory gearbox connecting the main rotor gearbox with one or more accessories, the first accessory gearbox having a non-pressurized lubrication system independent from a lubrication system associated with the main rotor gearbox; and a second accessory gearbox connecting the main rotor gearbox with one or more accessories, the second accessory gearbox having a non-pressurized lubrication system independent from a lubrication system associated with the main rotor gearbox, wherein the second accessory gearbox is independent from and redundant with the first accessory gearbox. In another aspect, the method further comprises mounting two or more hydraulic power packs wherein each of the two or more hydraulic power packs is independent from and redundant with the other hydraulic power packs. In another aspect, the method further comprises mounting two or more oil cooler blowers wherein each of the two or more oil cooler blowers is independent from and redundant with the other oil cooler blowers. In another aspect, the method further comprises mounting two or more generators wherein each of the two or more generators is independent from and redundant with the other generators.

In another embodiment, the present invention includes a helicopter, comprising: a fuselage; a main rotor gearbox comprising a first and a second input coupled to the fuselage; at least a first and a second engine; a first drive system comprising a first engine reduction gearbox connecting a first engine to the first input of the main rotor gearbox at a reduced shaft speed; a second drive system independent from and redundant with the first drive system, the second drive system comprising a second engine reduction gearbox connecting a second engine to the second input of the main rotor gearbox at the reduced shaft speed; and a rotor system connected to the main rotor gearbox to provide flight.

In addition to the foregoing, various other method, system, and apparatus aspects are set forth in the teachings of the present disclosure, such as the claims, text, and drawings forming a part of the present disclosure.

The foregoing is a summary and thus contains, by necessity, simplifications, generalizations, and omissions of detail. Consequently, those skilled in the art will appreciate that this summary is illustrative only and is not intended to be in any way limiting. There aspects, features, and advantages of the devices, processes, and other subject matter described herein will be become apparent in the teachings set forth herein.

### BRIEF DESCRIPTION OF THE DRAWINGS

For a more complete understanding of the features and advantages of the present invention, reference is now made to the detailed description of the invention along with the accompanying figures and in which:

FIG. 1 shows a side view of a helicopter according to a preferred embodiment of the present application;

FIG. 2 shows a partial cross-section, perspective view of helicopter aircraft according to an alternative embodiment of the present application;

FIG. 3 shows an isometric view of a drive system that depicts the present invention.

FIG. 4 shows a close-up, isometric view of a fan assembly for use with the drive system of the present invention.

FIG. 5 shows an isometric view of another portion of the drive system that provides system separation and redundancy.

FIG. 6 shows a main rotor gearbox of a helicopter according to an embodiment of the present application

### DETAILED DESCRIPTION OF THE INVENTION

Illustrative embodiments of the system of the present application are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

The present invention addresses the problems with drive systems in use today that are known to lead to rotorcraft failure. More particularly, the drive system of the present invention was designed to overcome drive system failures by including one or more of the following design features: (1) minimize the number of single path drive system components; (2) provide maximum system separation and redundancy; (3) minimize maintenance requirements and maintenance related incidents; (4) minimize the potential of loss of lubrication events; and/or (5) maximize main rotor gearbox loss of lubrication capability. The rotorcraft drive system described herein includes, e.g., dual engine reduction gearboxes completely isolated from the remainder of drive system via freewheeling clutches in the main rotor gearbox, dual accessory gearboxes separate from the main rotor gearbox, and the distribution of the gearbox driven accessories among the separate systems, among other improvements.

The present invention was developed to address the failures common to rotorcraft drive systems and is based on a completely new design and application of new technology to rotorcraft safety. More particularly, the new rotorcraft drive system is focused in an unparalleled manner on safety and redundancy. The goal of safety drove the design and development of the unique layout and configuration of the rotorcraft drive system described herein, which incorporates unique features and system separation that protects primary aircraft systems from the most common drive system failures. The drive system has also been designed to maximize the operational capability in the event of an uncommon failure, such as a loss of lubrication.

Moreover, the present inventors recognized that high-speed gearing and the associated heat generation is always an area of concern for gearbox survivability. The ability to continue torque transmission, particularly in a loss of lubrication scenario, is of great importance. For this reason, the drive system described herein includes two separate reduction gearboxes (RGB's), each one connected to a separate engine and independent from the Main Rotor Gearbox (MRGB). The reduction gearboxes are fully self-contained and separate from each other, each reducing the engine output speed from a high speed at or near turbine engine speed of greater than 10,000 RPM to a speed substantially lower than the high speed, a low speed of less than about 6,000 RPM, prior to transmitting torque to the MRGB. With this drive system arrangement high-speed gearing is contained in separate gearboxes, as such, the survivability of the total drive system is greatly enhanced, particularly in the event of high-speed gear failure or loss of lubricant in an individual RGB.

According to one embodiment, the MRGB has additional unique features including the low speed (less than about 6,000 RPM) input. The use of independent RGBs that connect to a single low speed overhung planetary gear system in the MRGB reduces rotating part count and heat generation. Low gear count is achieved by the use of compound gears that incorporate compartmentalized lubrication recovery elements and one or more independent and monitored chip detectors. With maintenance in mind, the drive system allows for a short mast top case assembly that allows swapping of the top case and mast without removal of the main rotor gearbox from the aircraft. The MRGB also includes a clutch for each input of the reduction gearboxes that allows each reduction gearbox to be separately and independently disconnected from the MRGB.

High-speed gearing and the associated heat generation is always an area of concern for gearbox survivability. The ability to continue torque transmission, particularly in a loss of lubrication scenario is of great importance. For this reason, the present invention includes a powertrain for a rotorcraft that includes two separate engine reduction gearboxes (RGB), e.g., one RGB for each engine of a two-engine rotorcraft. The reduction gearboxes are fully self-contained and separate from each other, reducing the engine output speed from a high speed at or near turbine engine speed of greater than 10,000 RPM to a speed substantially lower than the high speed, e.g., a low speed of less than about 6,000 RPM, prior to transmitting torque to the main rotor gearbox (MRGB). This rotational speed reduction is accomplished with, e.g., a simple three (3)-gear reduction. The rotational reduction can be accomplished with 2, 3, 4, 5, 6 or more gears; however, a 3 gear system provided the requisite reduction. Each RGB has its own self-contained lubrication system consisting of pump, filter, oil monitoring sensors, and a unique core in the aircraft cooler assembly.

With this arrangement, where high-speed gearing is contained in separate gearboxes, the survivability of the total drive system is greatly enhanced, particularly in the event of high speed gear failure or loss of lubricant in an individual RGB. Each reduction gearbox can be disconnected from the MRGB by a clutch.

The Main Rotor Gearbox (MRGB) transmits torque from the Reduction Gearboxes (RGB) to the main rotor mast, the accessory gearboxes, the hydraulic pump and generator that is mounted to the MRGB, and to the tail rotor drive shaft.

The drive system of the present invention can also take advantage of a number of additional features that minimize the possibility of loss of lubricant and to maximize the operational time if a loss of lubricant event does occur. For example, the drive system can also include one or more of the following: (1) the use of transfer tubes for cooler and filter mounting to eliminate the loss of lubricant in the event of loss of attachment fastener torque; (2) using an oil cooler mounted directly to the main rotor gearbox eliminating external hoses; (3) the use of all oil filter bowls are screw-on instead of held-on with small fasteners eliminating fastener failure issue from repeated removals; (4) the elimination of a high speed planetary and the heat generation associated with it during a loss of lubrication event; (5) the use of gear tooth geometry specifically designed to minimize sliding reducing heat generation at the teeth and the tendency to score during a loss of lubrication event; (6) the use of coarse pitch power gears with clearance or backlash allowing for the expansion during high heat loss of lubrication events; (7) the use of high hot hardness material utilized for primary torque carrying components maximizing their continued operation in the event of a loss of lubrication event; (8) the use of ring gear and case joint design to efficiently transmit heat away from the planetary gears in the event of a loss of lubrication event; and/or (9) the use of isotropic super finished gear teeth resulting in a greatly improved surface finish and maximizing the ability of these gears to operate in a reduced lubrication environment.

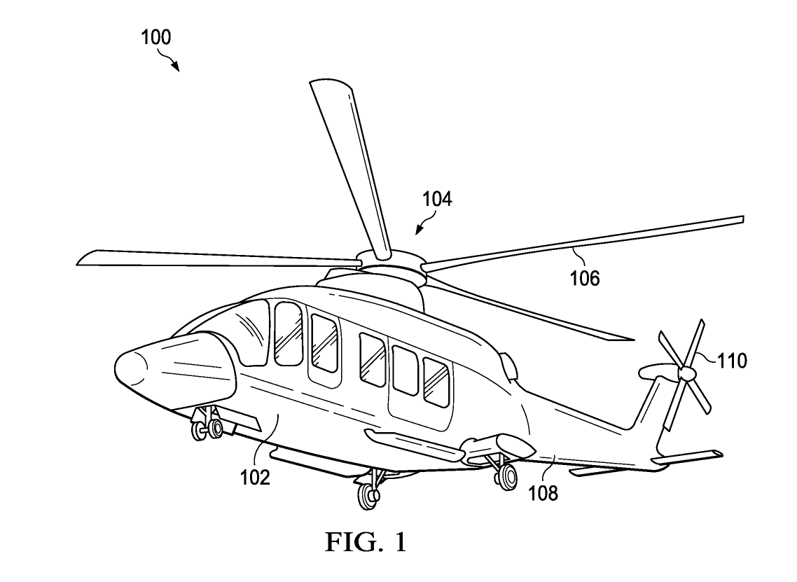

FIG. 1 shows a helicopter 100 in accordance with a preferred embodiment of the present application. In the exemplary embodiment, aircraft 100 is a helicopter having a fuselage 102 and a rotor system 104 carried thereon. A plurality of rotor blades 106 is operably associated with a rotor system 104 for creating flight. A tail boom 108 is depicted that further includes tail rotor 110.

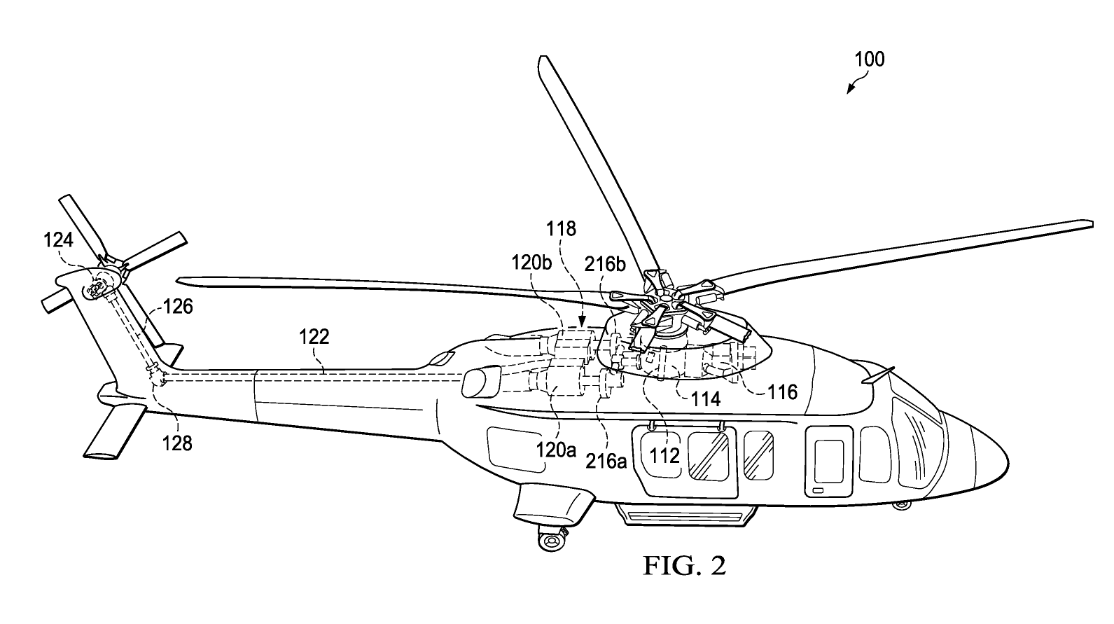

For example, FIG. 2 shows a partial cross-section perspective view of helicopter 100 that includes additional detail of an embodiment of the present invention. Helicopter 100 further includes a rotor mast 112, which is connected to the main rotor gearbox 114. The main rotor gearbox 114 is connected to one or more accessory gear boxes 116 and one or more engine reduction gearboxes 216a, 216b. Each engine reduction gearbox 216a, 216b is connected to one or more engines 120a, 120b, which are within an engine compartment 118. A tail rotor drive shaft 122 transmits mechanical rotation from the main rotor gearbox 114 to the tail rotor gear box 124, which is connected via tail rotor drive shaft 126 and intermediate gear box 128.

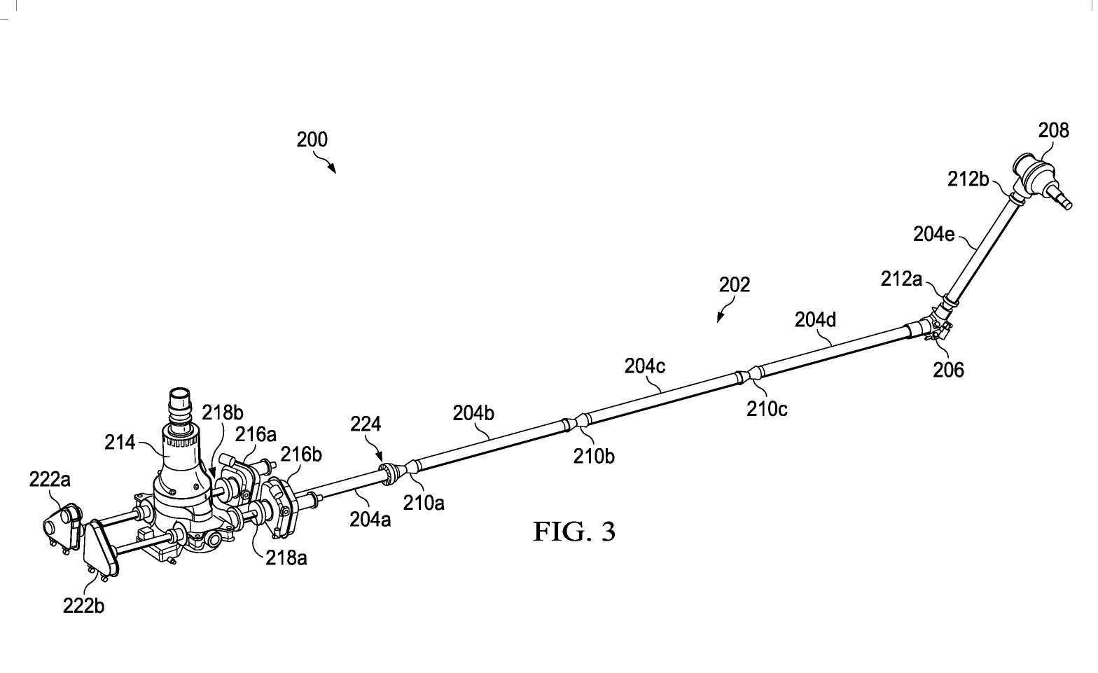

FIG. 3 shows a drive system 200 that includes a drive shaft assembly 202 that includes multiple drive shafts 204a, 204b, 204c, and 204d. Drive system 200 can also include a tail rotor drive shaft 204e. The drive shafts may be made from composite material, aluminum, titanium, or the like. In one example, drive shaft 204a is an aluminum driveshaft while the remaining drive shafts 204b, 204c, 204d, and 204e are composite drive shafts. Aluminum might be selected for the drive shaft 204a nearest the engines in order to maintain mechanical integrity in a high temperature environment, including, for instance, in the event of an engine fire. In another example, drive shafts 204a, 204b, 204c, 204d, and 204e are composite drive shafts. The drive shafts 204a, 204b, 204c, and 204d of drive shaft assembly 202 are connected by assemblies 210a, 210b, 210c (e.g., flexible couplings and hanger bearing assemblies) within the tail boom and under the engine(s). Where one or more of the drive shafts 204a, 204b, 204c, 204d, and 204e are composite drive shafts, a fan assembly 224 may be integrated into one or more connection assemblies 210a, 210b, 210c. For instance, where the drive shaft 204a nearest the engines is composite, a fan assembly 224 may be integrated into connection assembly 210a to provide air flow around drive shaft 204a in order to reduce the temperatures to which drive shaft 204a is normally exposed or to reduce the temperatures under abnormal conditions (e.g., in the event of an engine fire).

The drive shaft assembly 202 is connected at a distal end to an intermediate gearbox 206, which is connected to tail rotor gearbox 208 via drive shaft 204e and flexible couplings 212a, 212b. The proximal end of the drive shaft assembly 202 is connected to the main rotor gearbox, which is powered by two engine reduction gearboxes 216a, 216b, thereby providing redundant power to the main rotor gearbox 214 and the drive shaft assembly 202. Each of the engine reduction gearboxes 216a, 216b are sized to provide sufficient power to maintain flight to the main rotor gearbox 214 and to the drive shaft assembly 202 that is connected to the tail rotor gearbox 208. Each of the engine reduction gearboxes 216a, 216b is connected to the main rotor gearbox 214 via main rotor gearbox input shafts 218a, 218b and each of the engine reduction gearboxes 216a, 216b are connected to an engine (not depicted), e.g., a turboshaft engine. The main rotor gearbox input shafts 218a, 218b connect the engine reduction gearboxes 216a, 216b to the main rotor gearbox 214 via, e.g., couplings. The main rotor gearbox 214 is also depicted as also connected to accessory gearboxes 222a, 222b.

The skilled artisan will recognize that the novel drive system 200 of the present invention provides for the first time, a drive system configuration that was designed to: minimize the number of single load path components, provide maximum system separation and redundancy, minimize maintenance required and maintenance related incidents, minimize the potential of loss of lube events, and maximize main rotor gearbox loss of lube capability. Thus, by providing completely independent or redundant engine reduction gearboxes 216a, 216b, the loss of an engine reduction gearbox does not lead to loss of flight power, because each engine reduction gearbox 216a, 216b is completely isolated from the remainder of the drive system via freewheeling clutches located in the main rotor gearbox 214. As such, using the present invention loss of a single reduction gearbox does not prevent continued safe flight.

More particularly, the present invention separates all the high-speed rotating components from the main rotor gearbox, and moves them into redundant reduction gearboxes. As such, the design and components of the present invention are such that even when there is a failure in a reduction gearbox, such a failure does not impact the main rotor gearbox operation, because even if the failed reduction gearbox loses torque transmission (because of the inclusion of freewheeling clutches in the MRGB) the reduction gearbox still operating will provide sufficient power to maintain flight from the engine associated with the operational reduction gearbox to safely operate and land the aircraft. By moving the high-speed rotating components away from the main rotor gearbox, the present invention greatly reduces the time and expense of maintenance to replace a reduction gearbox as it is no longer necessary to disassemble the main rotor gearbox to replace components during scheduled maintenance or the result of a reduction gearbox failure.

Several key elements of the novel drive system 200 of the present invention include the separation of dual engine reduction gearboxes, which are completely isolated from remainder of drive system via freewheeling clutches in the main rotor gearbox. Further, the drive system 200 provides dual accessory gearboxes separate from the main rotor gearbox. In addition, the distribution of the gearbox driven accessories is among the separate systems, thereby providing, for the first time, full redundant systems. Due to the use of redundant and separate power pathways, the failure of some accessories that would otherwise be critical (e.g., loss of hydraulic pumps, cooling blowers, generators, etc.), is overcome by the separate power pathway. Thus, if one accessory gearbox fails, or if one of the accessories associated with an accessory gearbox fails, the remaining redundant accessory gearbox and its associated accessories are designed to provide for safely operating and landing of the aircraft.

The present invention can be used in conjunction with pressurized or non-pressurized accessory gearboxes. For instance, the pressurized or non-pressurized accessory gearboxes include the gears that connect to an output from the main rotor gearbox or the engines. The pressurized or non-pressurized gearboxes will generally include one or more of the following: an oil level gauge, an oil level sensor, an oil filler cap, and/or a sump chip The housing for the pressurized or non-pressurized accessory gearboxes can also include provisions for certain outputs, such as: a permanent magnet generator that generates an electrical output, a blower, a generator, or a hydraulic pump. The gears within the pressurized or non-pressurized accessory gearboxes are sized to provide the necessary speeds and torques required by each gearbox output. Typically, in non-pressurized gearboxes the internal parts of the gearbox are splash lubricated.

In certain embodiments, the accessory gearboxes have a lubrication system that is independent of the main rotor gearbox's lubrication system. This can decrease the frequency of loss-of-lube events by eliminating leak paths. Specifically, by providing independent lubrication systems for each of the accessory gearboxes, one can eliminate transfer tubes, hoses, and the like that would otherwise be necessary to provide circulation of lubricant between the main rotor gearbox and each of the accessory gearbox. Thus, in one embodiment, each of the accessory gearboxes has a non-pressurized lubrication system that is independent of the main rotor gearbox's lubrication system.

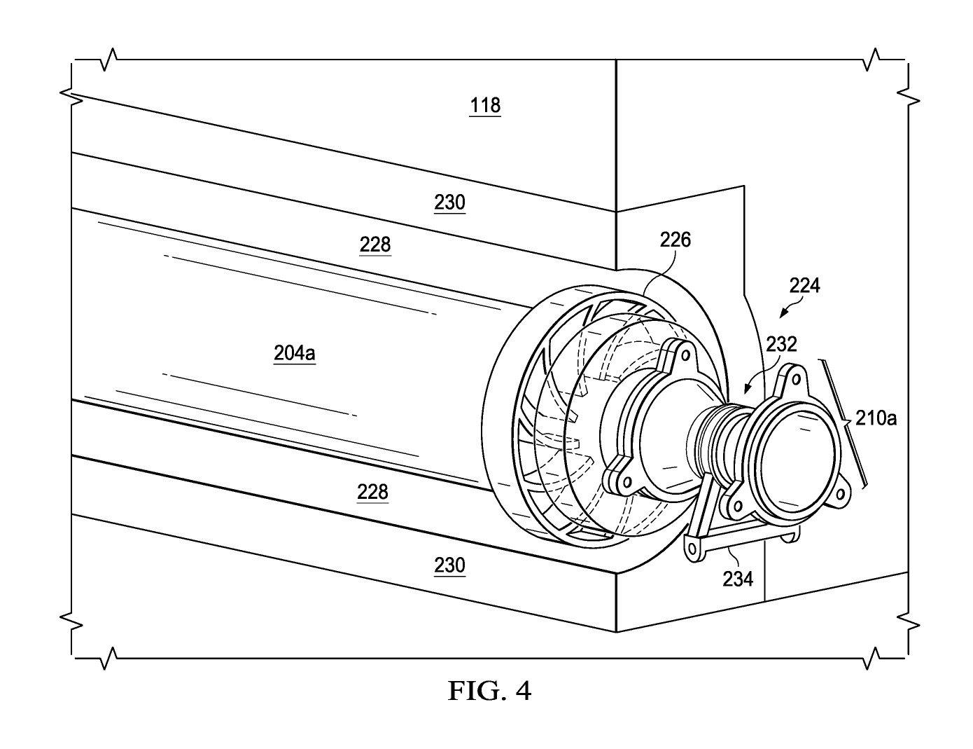

FIG. 4 shows a close-up, isometric view of a fan assembly 224 that is part of the drive system 200 of the present invention. Drive shaft 204a, which is nearest the engines, may be a composite or a metal shaft. The fan assembly 224 includes a fan 226 that may be integrated into connection assembly 210a and provides air flow over and around drive shaft 204a in order to reduce the temperatures to which drive shaft 204a is exposed (e.g., in the event of an engine fire). The drive shaft 204a is depicted in this embodiment within an opening 228 and surrounded by insulation 230, which also protects the drive shaft 204a from heat generated by the engine(s) (not depicted). The connection assembly 210a is depicted with a flexible coupling 232 and a hanger bearing assembly 234.

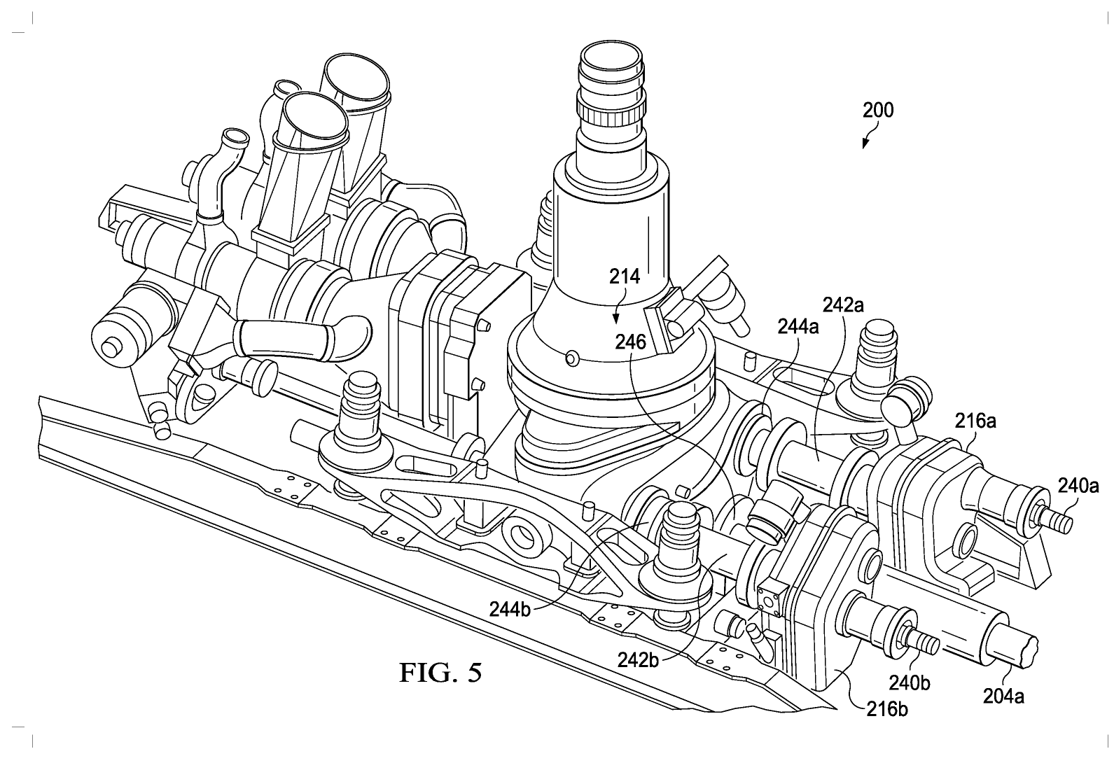

FIG. 5 shows an isometric view of a drive system 200 that provides maximum system separation and redundancy. Drive system 200 include two engine reduction gearboxes 216a, 216b, that are each depicted with an engine connection shaft 240a, 240b. In alternative embodiments, the engine reduction gearboxes 216a, 216b may be connected to one or more accessories, such as a generator, a blower, a pump or other accessory that draws power from the engine reduction gearboxes 216a, 216b. Each of the engine reduction gearboxes 216a, 216b is connected via a separate shaft 242a, 242b, to the main rotor gearbox 214. Thus, each of the engine connection shafts 240a, 240b provides a single drive system from the engines to the main rotor gearbox 214, each of which operates independently and redundantly to provide shaft power to the main rotor gearbox 214. Further, each of the engine reduction gearboxes 216a, 216b reduces the speed of rotation from the engine (e.g., up to a high speed at or near turbine engine speed of greater than 10,000 RPM) to a speed substantially lower than the high speed, a low speed of less than about 6,000 RPM prior to entering the main rotor gearbox 214. Thus, the main rotor gearbox 214 can be designed to operate more reliably, with components that are turning at a much lower speed. The drive system 200 also connects to the tail rotor via a tail rotor shaft 204. Each of the engine connection shafts 240a, 240b can further include, e.g., a clutch, or other mechanisms for connecting and disconnecting the engine reduction gearboxes 216a, 216b from the main rotor gearbox 214. Each of the shafts 242a, 242b can connect via freewheeling clutches 244a, 244b, depicted here on the main rotor gearbox 214, however, the skilled artisan will recognize that the freewheeling clutches 244a, 244b could also be positioned on the engine reduction gearboxes 216a, 216b or even between the engine reduction gearboxes 216a, 216b and the main rotor gearbox 214, or combinations of the same. Further, the shafts 242a, 242b that connect the engine reduction gearboxes 216a, 216b to the main rotor gearbox 214 can include flexible couplings to allow for pylon movement and can be separately uncoupled. For example, clutches can be connected to the shafts 242a, 242b, and/or to an output from the main rotor gearbox 214. In the embodiment of FIG. 4, these shafts 242a, 242b connect directly into the main rotor gearbox 214 at a freewheeling clutch 244a, 244b that allows the engines and reduction gearboxes 216a, 216b to have completely independent torque and speed. That is, in the event of an engine failure, or a loses torque transmission by one of the engine reduction gearboxes 216a, 216b, the associated freewheeling clutch 244a, 244b allows the main rotor gearbox 214 to continue operating at speed, receiving torque from the engine and engine reduction gearbox that remains operable. Further, each freewheeling unit allows for the individual start-up and shutdown of either engine. The shafts 242a, 242b can be, e.g., a one-piece drive shaft with integral couplings and anti-flail protection. The shafts 242a, 242b can be a single material or a composite material. Drive system 200 also includes a tail rotor disc brake 246 and calipers (not shown) for slowing or stopping drive system 200.

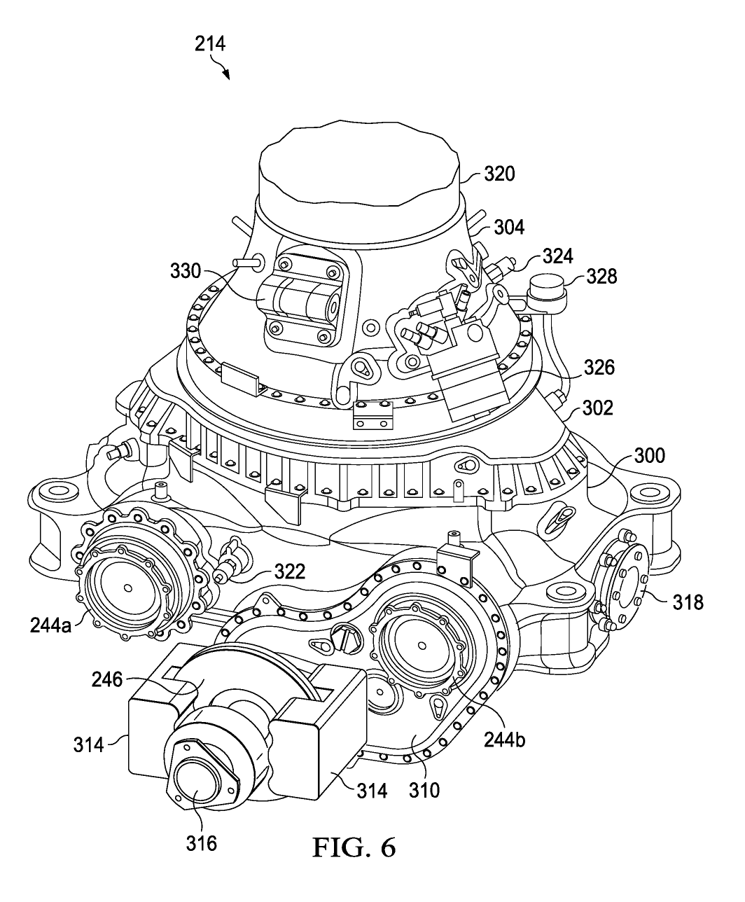

FIG. 6 shows a main rotor gearbox 214 of a helicopter according to an embodiment of the present application. The main rotor gearbox 214 includes a lower housing 302, a middle housing 304. Main rotor gearbox 214 includes a first drive input and clutch 244a, a second drive input and clutch 244b, a tail rotor gear assembly 310, a tail rotor disc brake 246 and calipers 314, a tail rotor drive output 316, a generator output 318, hydraulic pump drive output (not shown), first accessory drive output (not shown), second accessory drive output (not shown), oil pump drive output (not shown), and mast housing 320. Other features include tail rotor output section chip detector 322, mast bearing chip detector 324, planetary chip detector (not shown), oil filter 326, oil filler cap 328, non-rotating scissor link mounting bracket 330. The first drive input and clutch 244a and second drive input and clutch 244b allow for single engine start and decoupling of either engine/reduction gearbox for single engine operation. Thus, the main gear box 214 minimizes the number of single path drive system components and provides maximum system separation and redundancy.

Non-limiting examples of composite materials for use with the drive shafts include, e.g., metals, carbon fiber, metal-carbon fiber, fiber reinforcement unidirectional layers embedded in the thermoplastic polymer, or combinations thereof. For example, the composite drive shafts may be a composite tube that is a braided fiber and resin transfer molded component. Such components are typically more damage tolerant and have a higher ballistic survivability. The braided fiber may be either a two-dimensional or a three-dimensional braided fiber. However, it should be understood that the composite shaft may also be manufactured by filament winding, fiber placement, or any other processes that are deemed appropriate. The drive shafts can also include end adapters, which can be formed from a metallic material, such as aluminum, titanium, or steel, but may be formed from any other suitable rigid material, including non-metallic material. Composite materials and manufacturing of composite drive shafts are taught in, e.g., U.S. Pat. No. 7,335,108, relevant portions incorporated herein by reference.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of”. As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step or a limitation) or group of integers (e.g., feature(s), element(s), characteristic(s), propertie(s), method/process steps or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12 or 15%.

All of the devices and/or methods disclosed and claimed herein can be made and executed without undue experimentation in light of the present disclosure. While the devices and/or and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

Furthermore, no limitations are intended to the details of construction or design herein shown, other than as described in the claims below. It is therefore evident that the particular embodiments disclosed above may be altered or modified and all such variations are considered within the scope and spirit of the disclosure. Accordingly, the protection sought herein is as set forth in the claims below.

To aid the Patent Office, and any readers of any patent issued on this application in interpreting the claims appended hereto, applicants wish to note that they do not intend any of the appended claims to invoke paragraph 6 of 35 U.S.C. § 112 as it exists on the date of filing hereof unless the words “means for” or “step for” are explicitly used in the particular claim.

What is claimed is:

1. An aircraft drive system comprising:
a main rotor gearbox comprising a first and a second input;
a first drive system comprising a first engine reduction gearbox connecting a first engine to the first input of the main rotor gearbox at a reduced shaft speed; and
a second drive system independent from and redundant with the first drive system, the second drive system comprising a second engine reduction gearbox connecting a second engine to the second input of the main rotor gearbox at the reduced shaft speed.

2. The drive system of claim 1, wherein the first and second engine reduction gearboxes comprises a plurality of gears that reduce a shaft speed from the first and second engines from 10,000 or greater revolutions per minute at an input of the first and second engine reduction gearboxes, respectively, to about 6,000 or fewer revolutions per minute at an output of the first and second engine reduction gearboxes.

3. The drive system of claim 1, further comprising a drive shaft with flexible couplings connecting each of the first and second engine reduction gearboxes to the first and second inputs of the main rotor gearbox, respectively.

4. The drive system of claim 1, wherein each of the first and second engine reduction gearboxes is independently lubricated and cooled.

5. The drive system of claim 1, wherein each of the first and second engine reduction gearboxes are configured to be independently decoupled from the main rotor gearbox.

6. The drive system of claim 1, wherein an output shaft comprises a tail rotor disc brake and calipers for slowing or stopping the drive system.

7. The drive system of claim 1, wherein the main rotor gearbox comprises a low speed overhung planetary gear system.

8. The drive system of claim 1, further comprising a drive shaft assembly connected to an output of the main rotor gearbox, wherein the drive shaft assembly comprises one or more drive shafts, each of the drive shafts connected to one or more bearing assemblies, the drive shaft assembly having a proximal and a distal end, and an intermediate gear box connected to the distal end of the one or more drive shafts, wherein the intermediate gear box is connected to a tail rotor gearbox via a tail rotor drive shaft.

9. The drive system of claim 1, further comprising at least one of: one or more accessory gearboxes, one or more cooling fans, or one or more oil pumps, one or more hydraulic power packs, or one or more generators, each connected directly or indirectly to the main rotor gearbox independently.

10. The drive system of claim 1, further comprising an oil cooler mounted directly to the main rotor gearbox.

11. The drive system of claim 1, further comprising: a first accessory gearbox connecting the main rotor gearbox with one or more accessories, the first accessory gearbox having a non-pressurized lubrication system independent from a lubrication system associated with the main rotor gearbox; and a second accessory gearbox connecting the main rotor gearbox with one or more accessories, the second accessory gearbox having a non-pressurized lubrication system independent from a lubrication system associated with the main rotor gearbox, wherein the second accessory gearbox is independent from and redundant with the first accessory gearbox.

12. The drive system of claim 1, further comprising two or more hydraulic power packs wherein each of the two or more hydraulic power packs is independent from and redundant with the other hydraulic power packs.

13. The drive system of claim 1, further comprising two or more oil cooler blowers wherein each of the two or more oil cooler blowers is independent from and redundant with the other oil cooler blowers.

14. The drive system of claim 1, further comprising two or more generators wherein each of the two or more generators is independent from and redundant with the other generators.

15. A method of providing redundant power to a main rotor gearbox comprising:
providing the main rotor gearbox comprising a first and a second input;
connecting a first drive system comprising a first engine reduction gearbox connecting a first engine to the first input of the main rotor gearbox at a reduced shaft speed; and
connecting a second drive system independent from and redundant with the first drive system, the second drive system comprising a second engine reduction gearbox connecting a second engine to the second input of the main rotor gearbox at the reduced shaft speed.

16. The method of claim 15, wherein the first and second engine reduction gearboxes comprises a plurality of gears that reduce a shaft speed from the first and second engines from 10,000 or greater revolutions per minute at an input of the first and second engine reduction gearboxes, respectively, to about 6,000 or fewer revolutions per minute at an output of the first and second engine reduction gearboxes.

17. The method of claim 15, further comprising connecting a drive shaft with flexible couplings between each of the first and second engine reduction gearboxes and the first and second inputs of the main rotor gearbox, respectively.

18. The method of claim 15, wherein each of the first and second engine reduction gearboxes is independently lubricated and cooled.

19. The method of claim 15, wherein each of the first and second engine reduction gearboxes are configured to be independently decoupled from the main rotor gearbox.

20. The method of claim 15, wherein an output shaft comprises a tail rotor disc brake and calipers for slowing or stopping the drive system.

21. The method of claim 15, wherein the main rotor gearbox comprises a low speed overhung planetary gear system.

22. The method of claim 15, further comprising connecting a drive shaft assembly to an output of the main rotor gearbox, wherein the drive shaft assembly comprises one or more drive shafts, each of the drive shafts connected to one or more bearing assemblies, the drive shaft assembly having a proximal and a distal end, and an intermediate gear box connected to the distal end of the one or more drive shafts, wherein the intermediate gear box is connected to a tail rotor gearbox via a tail rotor drive shaft.

23. The method of claim 15, further comprising providing at least one of: one or more accessory gearboxes, one or more cooling fans, or one or more oil pumps, one or more hydraulic power packs, or one or more generators, each connected directly or indirectly to the main rotor gearbox independently.

24. The method of claim 15, further comprising mounting an oil cooler directly to the main rotor gearbox.

25. The method of claim 15, further comprising mounting a first accessory gearbox connecting the main rotor gearbox with one or more accessories, the first accessory gearbox having a non-pressurized lubrication system independent from a lubrication system associated with the main rotor gearbox; and a second accessory gearbox connecting the main rotor gearbox with one or more accessories, the second accessory gearbox having a non-pressurized lubrication system independent from a lubrication system associated with the main rotor gearbox, wherein the second accessory gearbox is independent from and redundant with the first accessory gearbox.

26. The method of claim 15, further comprising mounting two or more hydraulic power packs wherein each of the two or more hydraulic power packs is independent from and redundant with the other hydraulic power packs.

27. The method of claim 15, further comprising mounting two or more oil cooler blowers wherein each of the two or more oil cooler blowers is independent from and redundant with the other oil cooler blowers.

28. The method of claim 15, further comprising mounting two or more generators wherein each of the two or more generators is independent from and redundant with the other generators.

29. A helicopter, comprising:
a fuselage;
a main rotor gearbox comprising a first and a second input coupled to the fuselage;
at least a first and a second engine;
a first drive system comprising a first engine reduction gearbox connecting a first engine to the first input of the main rotor gearbox at a reduced shaft speed;
a second drive system independent from and redundant with the first drive system, the second drive system comprising a second engine reduction gearbox connecting a second engine to the second input of the main rotor gearbox at the reduced shaft speed; and
a rotor system connected to the main rotor gearbox to provide flight.
